(19) United States
(12) Patent Application Publication
(10) Pub. No.: US 2002/0127339 A1
(43) Pub. Date: Sep. 12, 2002

(54) Finishing process

(76) Inventors: Volkmar Schwitzky, Wurzburg (DE); Vincent Moreau, Lausanne (CH); Boris Lotscher, Lausanne (CH)

Correspondence Address: Alison Kessler, Goodwin Procter LLP, Counsellors at Law, Seven Becker Farm Road, Roseland, NJ, 07068, US

(21) Appl. No.: 10/055,822

(22) Filed: Jan. 23, 2002

Related U.S. Application Data
(63) Continuation of application No. PCT/DE00/02330, filed on Jul. 15, 2000.

(30) Foreign Application Priority Data
Jul. 28, 1999 (DE) 199 35 170.8

(51) Int. Cl. B05D 5/00

(52) U.S. Cl. 427/258

(57) ABSTRACT

The invention relates to a method for finishing valuable printed paper sheets. The purpose of said finishing method is to improve the recognition of security features. For that purpose, the valuable printed paper sheets are partly or entirely covered with a varnish used for increasing the durability of said valuable printed paper sheets and for enhancing said security features.

The invention relates to a process for finishing printed securities sheets.

The watermark, which is produced already during the production of the “securities paper”, is a well-known safety feature of securities paper.

Watermarks are produced in that a selectively different construction of the body of the paper with respect to the thickness and/or the density of the material is achieved by appropriate processes during the manufacture of the paper.

The desired motifs (such as portraits) can be produced in the paper by the different construction, that is, by the different light transparency of the material, which is achieved. In this connection, it is a disadvantage that the motif becomes clearly visible only when the paper is placed on a light table or held against light. Moreover, these papers are worn away heavily during use so that, as a result, it is no longer possible in some cases to identify the safety feature.

It is an object of the invention to provide a process for finishing printed securities sheets, so that the safety features can be identified better.

Pursuant to the invention, this objective is accomplished by the distinguishing features of the first claim.

By lacquering printed securities paper, especially with a colorless lacquer, the transparency of the paper is increased greatly, depending on the construction of the paper, the type of lacquer, the method of applying the lacquer and the amount applied. If a watermark of a securities paper is lacquered on one or both sides, the motif of the watermark is visible more clearly, because of the different transparency, which results from the different construction of the paper. The watermark can be recognized clearly even without help (such as a source of light). This effect is intensified, for example, by sources of light or simply by a dark base.

In the following, the process is explained in greater detail by means of an example. A securities sheet, which has been provided, for example, with safety features such as watermarks, is printed in a printing press. Subsequently, that is, after the printing process, the printed securities sheet is lacquered in the printing press with a special lacquering device or in an external lacquering facility with a feeding apparatus and a sheet delivery apparatus.

Advisably, the whole sheet is lacquered and certain parts of the whole sheet, that is, the part of the sheet with the watermark, are lacquered. Partial lacquering improves the identifiability of the safety features and lacquering the whole sheet prolongs the identifiability of the safety features and the service life of the securities, when the latter are used for a prolonged time.

So that the manufacturing process of the securities is prolonged by the lacquering, it is advantageous to carry out the lacquering process, namely the total and partial lacquering, in one step. For this purpose, a first lacquering unit, comprising a lacquering cylinder and a screen roller with doctor blade, is assigned to a printing cylinder and a second lacquering unit, comprising a lacquering cylinder and screen roller with doctor blade, is disposed upstream from the lacquering cylinder.

The lacquering is carried out with colorless lacquer.

1. A method for finishing printed securities sheets, wherein printed securities sheets are lacquered completely and/or partly in order to increase the durability and to emphasize distinguishing features.

2. The method for finishing of claim 1, wherein the distinguishing features are emphasized by increasing the transparency of the printed sheet by applying a layer of lacquer.

3. The method for finishing of claim 1, wherein the printed securities sheet is coated in one step over its whole surface with a first layer of lacquer and partially with a second layer of lacquer.

4. The method for finishing of claim 1, wherein in the features are safety features.

5. The method for finishing of claim 4, wherein the safety features are watermarks.

6. The method for finishing of claim 1, wherein a colorless lacquer is used for the lacquering.
